(19) United States
(12) Patent Application Publication
(10) Pub. No.: US 2015/0145972 A1
(43) Pub. Date: May 28, 2015

(54) LIQUID CRYSTAL DISPLAY DEVICE AND METHOD FOR CONTROLLING SAME

(71) Applicant: Sharp Kabushiki Kaisha, Osaka (JP)

(72) Inventors: Kentaroh Irie, Osaka (JP); Masae Kawabata, Osaka (JP); Shinji Matsumoto, Osaka (JP)

(73) Assignee: Sharp Kabushiki Kaisha, Osaka (JP)

(21) Appl. No.: 14/404,996

(22) PCT Filed: May 29, 2013
(86) PCT No.: PCT/JP2013/064854

§ 371 Date: Dec. 2, 2014

(30) Foreign Application Priority Data
Jun. 5, 2012 (JP) 2012-127907

(51) Int. Cl. G09G 3/36; H04N 13/00; G02F 1/1335

(52) U.S. Cl. CPC G09G 3/3607; G02F 1/133603; H04N 13/0025; G02F 2001/133612; G09G 2320/0233; G09G 2320/0209; H04N 13/0486
USPC 348/55; 345/690; 345/58; 345/87

(57) ABSTRACT

Provided is a liquid crystal display device with which it is possible to suppress degradation of image quality during video display or three-dimensional display without causing gradational luminance irregularities. Writing of an image to be displayed is sequentially performed from one side of a panel to the other side thereof during each frame period, and writing of a black image is sequentially performed from the one side of the panel to the other side thereof during the vertical blanking period in each frame period. A plurality of LEDs composing a backlight are divided into a plurality of segments so that a group of LEDs arrayed in a line in the direction in which scanning signal lines extend belong to the same segment. A segment lighting control circuit in a backlight control circuit controls emission intensities of the LEDs segment by segment so that the intensity of light irradiating the panel increases gradually from the one side of the panel to the other side thereof.

### TECHNICAL FIELD

The present invention relates to a liquid crystal display device, and more specifically, to a liquid crystal display device that performs image display while inserting a black image to mitigate a decrease in display quality.

### BACKGROUND ART

Conventionally, as display devices, impulse type display devices such as CRTs and hold type display devices such as liquid crystal display devices are known. When focusing on individual pixels in impulse type display devices, an illumination period when images are displayed and a non-illumination period when images are not displayed occur alternately. Even when displaying videos, for example, when rewriting one frame, a non-illumination period is inserted, and thus, there are no residual images of moving objects perceived by the human viewer. Thus, the background and object can be distinguished and a video with a natural appearance can be viewed. On the other hand, in liquid crystal display devices, which are display devices of the hold type, the luminance of each pixel is maintained throughout a frame period, which is a period during which one frame is rewritten. As a result, when liquid crystal display devices display videos, a residual image of a moving object is perceived by the human viewer. Specifically, an outline of the moving object is perceived in a blurred state. This phenomenon is referred to as “motion blur” or the like, and is thought to be a result of a tendency for human eyes to follow motion. As a method of mitigating motion blur in a liquid crystal display device, a method is known in which pseudo-impulse type image display is performed by displaying a black image in one frame period.

Also, in recent years, many liquid crystal display devices that can display three dimensional images such as 3D televisions are being sold. In liquid crystal display devices that employ the field sequential method, which is one method of attaining three dimensional display, a left eye image and a right eye image are alternately displayed in a liquid crystal panel per prescribed period ( 1/120 of a second, for example), and lenses of active shutter 3D glasses alternately open and close in synchronization therewith. In this manner, an image with parallax between the left eye and the right eye is perceived, and the viewer sees this image as being three dimensional.

In liquid crystal display devices that can display in three dimensions, decreasing crosstalk is more of an issue than before. Crosstalk refers to the phenomenon in which a left eye image is also seen by the right eye of the viewer and a right eye image is also seen by the left eye of the viewer, resulting in the left eye image and the right eye image being perceived as overlapping each other. As countermeasures to minimize a decrease in image quality resulting from crosstalk, an increase in drive frequency of liquid crystal panels, improvement in light emission by LED backlights, and improvements in liquid crystal responsiveness have been conventionally done. Also, in the period between the left eye image display period and the right eye image display period, a black image is similarly inserted as a countermeasure against motion blur.

In relation to the present invention, Japanese Patent Application Laid-Open Publication No. 2010-164976 discloses a configuration in which the amount of light emitted from illumination regions of a backlight is controlled for each individual illumination region based on an image signal in a display device having an image display region divided into a plurality of regions.

### RELATED ART DOCUMENTS

### Patent Documents

Patent Document 1: Japanese Patent Application Laid-Open Publication No. 2010-164976

### SUMMARY OF THE INVENTION

### Problems to be Solved by the Invention

One method of mitigating motion blur or realizing a relatively low cost liquid crystal display device that can display three dimensional images, is to perform writing of a black image to a liquid crystal panel during a vertical blanking period in each frame period at twice the driving speed (here, “writing” refers to charging pixel capacitance in the liquid crystal panel based on a target potential image signal). However, in such a case, as shown in FIG. 19, a graded unevenness in luminance occurs in the vertical direction (direction in which image signal lines extend) on the screen. This will be explained below.

FIG. 20 schematically shows a progression of image writing in each position on the liquid crystal panel when writing of the black image during the vertical blanking period is performed. Here, an example is given of a liquid crystal display device that can display in three dimensions. In FIG. 20, the vertical axis indicates the position on the liquid crystal panel and the horizontal axis indicates time. The arrow with the reference character 91 shows writing of a normal image (left eye image or right eye image) being performed from the top to the bottom of the panel during the display period in each frame period. The arrow with the reference character 92 indicates writing of a black image being performed from the top to the bottom of the panel during the vertical blanking period in each frame period. When focusing on a position P1 on the liquid crystal panel in FIG. 20, for example, then during a period indicated with the reference character T1 during one frame period, normal image display is performed, and during a period indicated with the reference character T2, black image display is performed. The length of the vertical blanking period is shorter than the length of the display period, and thus, the proportion of the display period when a black image is displayed during the one frame period (hereinafter referred to as the “black insertion rate”) becomes gradually larger from the top of the panel to the bottom of the panel. As a result, the luminance on the screen is different along the vertical direction of the liquid crystal panel. In this manner, as shown in FIG. 19, a graded luminance unevenness occurs in the vertical direction on the screen of the liquid crystal panel. In liquid crystal display devices other than those that can display in three dimensions, similar luminance unevenness occurs if a configuration in which a black image is written during the vertical blanking period is adopted. In the display device disclosed in Japanese Patent Application Laid-Open Publication No. 2010-164976, the amount of light emitted from the backlight is adjusted based on the image signal, and it is not possible to mitigate the occurrence of luminance unevenness resulting from writing of the black image with the technique of this display device.

An object of the present invention is to provide a liquid crystal display device by which it is possible to mitigate a decrease in image quality when displaying video or displaying in three dimensions without the occurrence of graded luminance unevenness.

### Means for Solving the Problems

A first aspect of the present invention is a liquid crystal display device, including:

a liquid crystal panel including a plurality of scan signal lines and a plurality of image signal lines that intersect with the plurality of scan signal lines;

a plurality of light sources as a backlight that radiates light to a rear surface of the liquid crystal panel;

a light source control unit that controls an intensity of light emitted by the plurality of light sources; and

a liquid crystal panel driving unit that drives the liquid crystal panel, wherein the plurality of light sources are divided into a plurality of groups such that a set of light sources aligned in a direction extending along the plurality of scan signal lines belongs to a same group,

wherein the liquid crystal panel driving unit writes an image to normally be displayed to the liquid crystal panel every frame period from one edge to an opposite edge of the liquid crystal panel in a direction extending along the plurality of image signal lines, and writes a black image from the one edge to the opposite edge of the liquid crystal panel during a vertical blanking period in each frame period, and

wherein the light source control unit controls the intensity of light emitted the plurality of light sources for each group such that the intensity of light radiated to the liquid crystal panel increases from the one edge to the opposite edge of the liquid crystal panel.

A second aspect of the present invention is the first aspect of the present invention,

wherein the liquid crystal panel driving unit writes a left eye image and a right eye image as the image to be displayed to the liquid crystal panel in alternating frame periods, and

wherein the liquid crystal panel displays a three dimensional image by alternately displaying the left eye image and the right eye image.

A third aspect of the present invention is the second aspect of the present invention, wherein the light source control unit sequentially illuminates a set of light sources belonging to each group during each prescribed period, starting from a group at the one edge of the liquid crystal panel to a group at the opposite edge of the liquid crystal panel.

A fourth aspect of the present invention is the first aspect of the present invention, wherein the light source control unit adjusts the intensity of light emitted from each group among the plurality of light sources on the basis of temperature data indicating a detected temperature.

A fifth aspect of the present invention is the fourth aspect of the present invention, further including:

a temperature detection unit that detects a surrounding temperature,

wherein the light source control unit receives, from the temperature detection unit, data indicating a temperature detected by the temperature detection unit as the temperature data.

A sixth aspect of the present invention is the fourth aspect of the present invention, wherein the light source control unit receives, from an external temperature detection unit, data indicating a temperature detected by the external temperature detection unit as the temperature data.

A seventh aspect of the present invention is the fourth aspect of the present invention, further including:

a lookup table that stores control data for adjusting the intensity of light emitted by the light sources on the basis of temperature, the control data being listed for each group of the light sources for possible detected temperatures that would be indicated by the temperature data,

wherein the light source control unit adjusts the intensity of light emitted by each group among the plurality of light sources in accordance with the control data listed in the lookup table for the detected temperature indicated by the temperature data.

An eighth aspect of the present invention is the first aspect of the present invention, wherein the light source control unit switches on and off a set of light sources belonging to each group on the basis of a duty ratio pre-determined for each group in order to control the intensity of light emitted by each group among the plurality of light sources.

A ninth aspect of the present invention is the first aspect of the present invention, wherein the light source control unit controls for each group a size of a current for driving the light sources in order to control the intensity of light emitted from each group among the plurality of light sources.

A tenth aspect of the present invention is the first aspect of the present invention, wherein the plurality of light sources are light-emitting diodes.

An eleventh aspect of the present invention is the first aspect of the present invention, wherein the plurality of light sources are disposed in a planar manner to a rear of the liquid crystal panel.

A twelfth aspect of the present invention is the first aspect of the present invention, wherein the plurality of light sources are disposed in a row along a side face of the liquid crystal panel.

A thirteenth aspect of the present invention is a method of controlling a liquid crystal display device including: a liquid crystal panel having a plurality of scan signal lines and a plurality of image signal lines intersecting with the plurality of scan signal lines; and a plurality of light sources as a backlight that radiates light to a rear surface of the liquid crystal panel, the method including:

controlling an intensity of light emitted by the plurality of light sources; and

driving the liquid crystal panel,

wherein the plurality of light sources are divided into a plurality of groups such that a set of light sources aligned in a direction extending along the plurality of scan signal lines belongs to a same group,

wherein, in the step of driving the liquid crystal panel, an image to normally be displayed to the liquid crystal panel is written to the liquid crystal panel every frame period from one edge to an opposite edge of the liquid crystal panel in a direction extending along the plurality of image signal lines, and a black image is written to the liquid crystal panel from the one edge to the opposite edge of the liquid crystal panel during a vertical blanking period in each frame period, and

wherein, in the step of controlling the light sources, the intensity of light emitted from the plurality of light sources is controlled for each group such that the intensity of light radiated to the liquid crystal panel increases from the one edge to the opposite edge of the liquid crystal panel.

A fourteenth aspect of the present invention is the thirteenth aspect of the present invention, wherein, in the step of controlling the light sources, the intensity of light emitted from the plurality of light sources is adjusted for each group on the basis of temperature data indicating a detected temperature.

### Effects of the Invention

According to the first aspect of the present invention, in the liquid crystal display device, writing of a black image to the liquid crystal panel occurs during the vertical blanking period of each frame period. The vertical blanking period is a small portion of one frame period, and thus, the writing of the black image occurs over a shorter period of time compared to the writing of a normal image. The writing of the image occurs from one end to another end of the liquid crystal panel, and thus, from one end to the other end, the black insertion rate (proportion of black image display time within one frame period) becomes larger. However, the light source control unit controls the intensity of light emitted from the light sources for each group such that the intensity of light radiated to the liquid crystal panel increases from one end to the other end of the liquid crystal panel. As a result, the difference in luminance in the vertical direction (direction in which image signal lines extend) on the liquid crystal panel decreases. As a result of writing the black image, the occurrence of motion blur when displaying video or crosstalk during three-dimensional display is mitigated. Thus, a liquid crystal display device by which it is possible to mitigate a decrease in image quality when displaying video or three-dimensional images without graded luminance unevenness is realized.

According to the second aspect, a decrease in image quality resulting from crosstalk is mitigated without causing graded luminance unevenness in a liquid crystal display device that can display in three dimensions.

According to the third aspect of the present invention, the plurality of light sources constituting the backlight or sequentially turned on/off for each group. Thus, when a normal image (left eye image or right eye image) is displayed in a region corresponding to a certain group, other light sources are off. As a result, a situation in which the viewer perceives a plurality of images mixed together is mitigated. Thus, crosstalk is effectively mitigated, and it is possible to increase display quality when displaying three-dimensional images.

According to the fourth aspect of the present invention, the intensity of light emitted from the light sources is adjusted by group in accordance with the temperature surrounding the liquid crystal display device. Thus, it is possible to attain effects similar to the first aspect of the present invention while mitigating the occurrence of luminance unevenness resulting from temperature changes.

According to the fifth aspect of the present invention, in a liquid crystal display device including a temperature detection unit, it is possible to attain effects similar to the first aspect of the present invention while mitigating the occurrence of luminance unevenness resulting from temperature change.

According to the sixth aspect of the present invention, in a liquid crystal display device that obtains temperature data from an external source, it is possible to attain effects similar to the first aspect of the present invention while mitigating the occurrence of luminance unevenness resulting from temperature change.

According to the seventh aspect of the present invention, it is possible to minutely adjust the intensity of light emitted from the light sources by including a suitable lookup table. As a result, luminance unevenness resulting from temperature change can be effectively mitigated.

According to the eighth aspect of the present invention, the light sources are switched on/off on the basis of a duty ratio, and thus, by changing the duty ratio, the intensity of light emitted from the light sources changes. Thus, it is possible to control the intensity of light emitted from the light sources for each group with relative ease.

According to the ninth aspect of the present invention, it is possible to control the intensity of light emitted from the light sources for each group without switching the light sources on and off.

According to the tenth aspect of the present invention, not only can effects similar to those of the first aspect of the present invention be attained, it is also possible to reduce power consumption.

According to the eleventh aspect of the present invention, effects similar to those of the first aspect of the present invention can be attained in a liquid crystal display device using a direct lit backlight.

According to the twelfth aspect of the present invention, effects similar to those of the first aspect of the present invention can be attained in a liquid crystal display device using an edge lit backlight.

According to the thirteenth aspect of the present invention, in the method of controlling the liquid crystal display device, effects similar to the first aspect of the present invention can be attained.

According to the fourteenth aspect of the present invention, in the method of controlling the liquid crystal display device, effects similar to the fourth aspect of the present invention can be attained.

### BRIEF DESCRIPTION OF THE DRAWINGS

FIG. 1 is a block diagram showing a configuration of a backlight control circuit of a liquid crystal display device according to Embodiment 1 of the present invention.

FIG. 2 is a block diagram showing an overall configuration of a liquid crystal display device of Embodiment 1.

FIG. 3 is a plan view showing a configuration of a backlight of Embodiment 1.

FIG. 4 is a plan view showing a configuration of a backlight of another example of Embodiment 1.

FIG. 5 is a drawing for describing a method of realizing three dimensional display in Embodiment 1.

FIG. 6 is a drawing for describing a method of realizing three dimensional display in Embodiment 1.

FIG. 7 schematically shows the progression of image writing in each position on the liquid crystal panel in Embodiment 1.

FIG. 8 schematically shows the progression of image writing in each position on the liquid crystal panel in Embodiment 1.

FIG. 9 is a drawing for describing control of light-emitting intensity of LEDs in Embodiment 1.

FIG. 10 is a drawing for describing effects of Embodiment 1.

FIG. 11 shows the duty cycle for each segment in Modification Example 1 of Embodiment 1.

FIG. 12 is a drawing for describing a method of driving a backlight according to Modification Example 2 of Embodiment 1.

FIG. 13 is a block diagram showing an overall configuration of a liquid crystal display device of Embodiment 2 of the present invention.

FIG. 14 is a block diagram showing a configuration of a backlight control circuit of Embodiment 2.

FIG. 15 is a drawing showing one configuration example of a lookup table for temperature-based control in Embodiment 2.

FIG. 16 is a drawing that shows a configuration of a frame period in a liquid crystal display device according to Embodiment 3 of the present invention.

FIG. 17 shows the progression of a frame period in Embodiment 3.

FIG. 18 schematically shows the progression of image writing in each position on the liquid crystal panel in Embodiment 3.

FIG. 19 schematically shows graded luminance unevenness occurring when a configuration of writing a black image during a vertical blanking period is adopted.

FIG. 20 schematically shows a progression of image writing in each position on the liquid crystal panel when writing of the black image during the vertical blanking period is performed.

### DETAILED DESCRIPTION OF EMBODIMENTS

Below, embodiments of the present invention will be explained with reference to the appended figures.

### 1. Embodiment 1

<1.1 Overall Configuration and Summary of Operation>

FIG. 2 is a block diagram showing an overall configuration of a liquid crystal display device of Embodiment 1 of the present invention. The liquid crystal display device includes a liquid crystal panel 10, a backlight 20, a panel drive control circuit 30 (liquid crystal panel driving unit), and a backlight control circuit 40. The liquid crystal display device is configured to be able to display in three dimensions. As a method of attaining three dimensional display, the frame sequential method in which a left eye image and a right eye image are alternately displayed is adopted. Typically, so-called double speed driving is adopted.

The liquid crystal panel 10 includes a display unit 11. The display unit 11 is provided with a plurality of image signal lines SL and a plurality of scan signal lines GL. At each intersection of image signal lines SL and scan signal lines GL, a pixel formation unit that forms pixels is provided. In other words, the display unit 11 includes a plurality of pixel formation units. The plurality of pixel formation units are arranged in a matrix in a pixel array. Each pixel formation unit includes a thin film transistor 12 (TFT), which is a switching element having a gate terminal connected to a scan signal line GL passing through the corresponding intersection and a source terminal connected to an image signal line passing through the corresponding intersection, a pixel electrode 13 connected to a drain terminal of the thin film transistor 12, a common electrode 14, which is an opposite electrode for applying a common potential to the plurality of pixel formation units, and a liquid crystal layer sandwiched between the pixel electrode 13 and the common electrode 13 provided in common with the plurality of pixel formation unit. An image capacitance CP is formed by a liquid crystal capacitance formed by the pixel electrode 13 and the common electrode 14. Generally, an auxiliary capacitance is provided in parallel with the liquid crystal capacitance in order to reliably maintain voltage in the pixel capacitance Cp, but the auxiliary capacitance is not directly related to the present invention, and thus, descriptions and depictions thereof are omitted. In the display unit 11 in FIG. 2, only components corresponding to one pixel formation unit are shown.

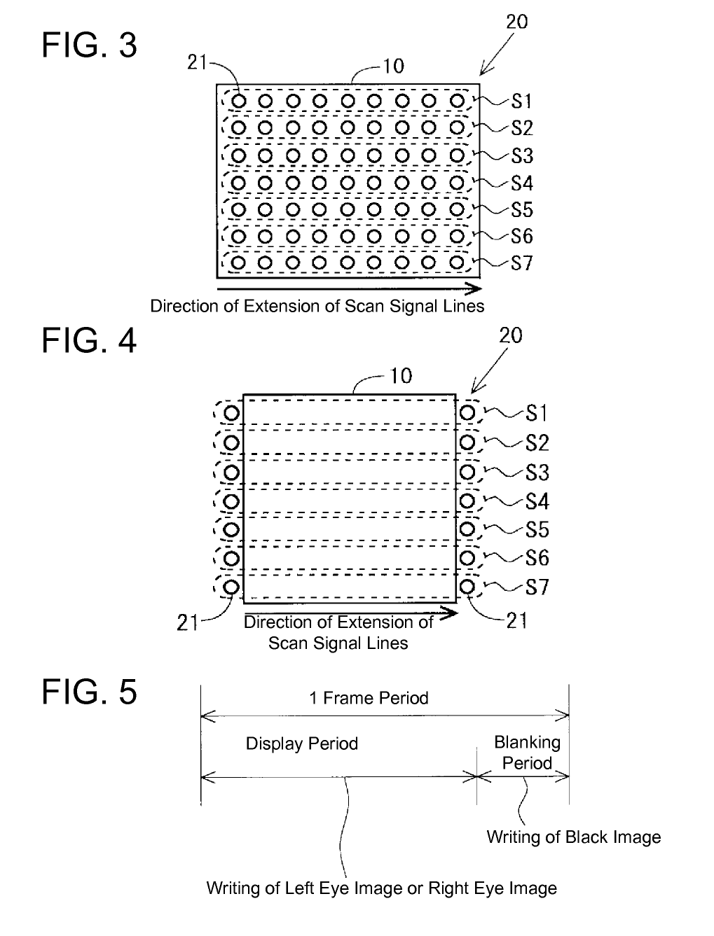

The backlight 20 is provided on the rear surface side of the liquid crystal panel 10 and radiates light to the rear surface of the liquid crystal panel 10. Here, LEDs (light emitting diodes) are assumed to be used as the light sources of the backlight. However, light sources other than LEDs can be used (cold cathode ray tubes, for example) as the light sources of the backlight, as long as the light sources can be electrically controlled. FIG. 3 is a plan view that shows a backlight 20 of the present embodiment. As shown in FIG. 3, the backlight 20 is constituted of a plurality of LEDs 21 disposed in a plane directly below the liquid crystal panel 10 (rear surface side). In other words, in the present embodiment, a direct lit type backlight is used. An edge-lit type backlight in which LEDs 21 are provided on both edges (side faces) of the liquid crystal panel 10 as shown in FIG. 4 can be adopted.

In the present embodiment, the plurality of LEDs 21 constituting the backlight 20 are divided into segments S1 to S7 such that each group of LEDs 21 arranged in a direction along a scan signal line GL belong to the same segment (group). The segments S1 to S7 respectively correspond to a prescribed number of scan signal lines GL. The number of segments can be a number other than seven. Also, in the description below, with respect to the regions on the liquid crystal panel 10, the region corresponding to the segment S1 is referred to as the “top portion of the panel” and the region corresponding to the segment S7 is referred to as the “bottom portion of the panel.” In the present embodiment, the top portion of the panel corresponds to one edge of the liquid crystal panel 10, and the bottom portion of the panel corresponds to the other edge of the liquid crystal panel 10.

The panel drive control circuit 30 is a circuit for driving the liquid crystal panel 10. The panel drive control circuit 30 includes a scanning signal line driver circuit that drives the scan signal lines GL and an image signal line driver circuit for driving the image signal lines SL. The panel drive control circuit 30 receives a digital image signal DS including left eye gradation data and right eye gradation data and a group of timing signals TG including horizontal synchronizing signals, vertical synchronizing signals, and the like from an external source, and outputs a scan signal G to the scan signal lines GL and driving image signals VS to the image signal lines SL. It is assumed that the scanning of the scan signal lines GL during each frame period occurs in the order of the top of the panel to the bottom of the panel.

The backlight control circuit 40 is a circuit for driving the backlight 20. The backlight control circuit 40 outputs a backlight control signal BS for controlling the intensity of light outputted by each LED 21 as the light source of the backlight on the basis of the digital image signal DS and the group of timing signals TG.

In the manner above, the image signal VS is applied to the respective image signal lines SL, the scan signal G is applied to the scan signal lines GL, and the intensity of light emitted by the LEDs 21 based on the backlight control signal BS is controlled, thereby causing a three dimensional image based on a digital image signal DS sent from outside to be displayed in the display unit 11.

<1.2 Backlight Control Circuit>

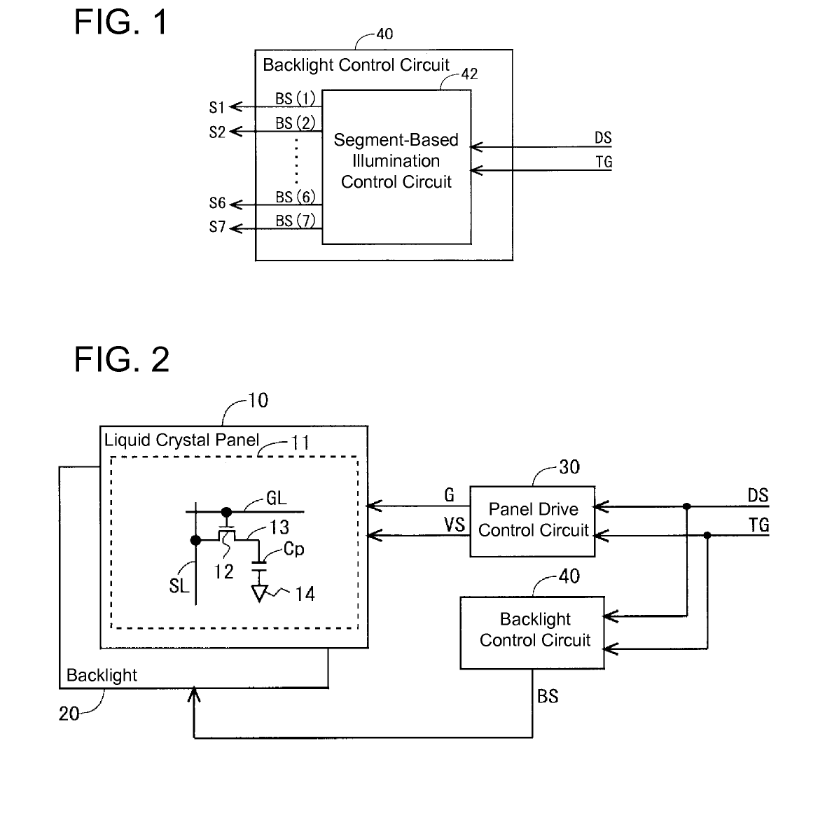

FIG. 1 is a block diagram that shows a backlight control circuit 40 of the present embodiment. As shown in FIG. 1, the backlight control circuit 40 includes a segment-based illumination control circuit 42. In the present embodiment, the segment-based illumination control circuit 42 is the light source control unit. The segment-based illumination control circuit 42 controls the intensity of light of the LEDs 21 for each segment based on the digital image signal DS and the group of timing signals TG. In FIG. 1, the backlight control signal for controlling the intensity of light emitting by the LEDs 21 included in the segment S1 is indicated with the reference character BS(i) (in the present embodiment, i is an integer from 1 to 7). According to the configuration above, it is possible to have different intensities of light emitted from the LEDs 21 for each segment.

<1.3 Method of Realizing Three Dimensional Display>

Next, a method of realizing three dimensional display of the present embodiment will be described. In the present embodiment, three dimensional display is realized according to the frame sequential method. In other words, the left eye image and the right eye image are alternately displayed in the liquid crystal panel 10, and the lenses of active shutter glasses alternately open and close in synchronization therewith. In the present embodiment, an image is displayed using the left eye image and the right eye image. One frame period includes a display period which is a period during which writing of a left eye image or a right eye image to the liquid crystal panel is performed, and a vertical blanking period, and in the present embodiment, a black image is written to the liquid crystal panel during the vertical blanking period (see FIG. 5). Normally, the length of the vertical blanking period is markedly shorter than that of the display period.

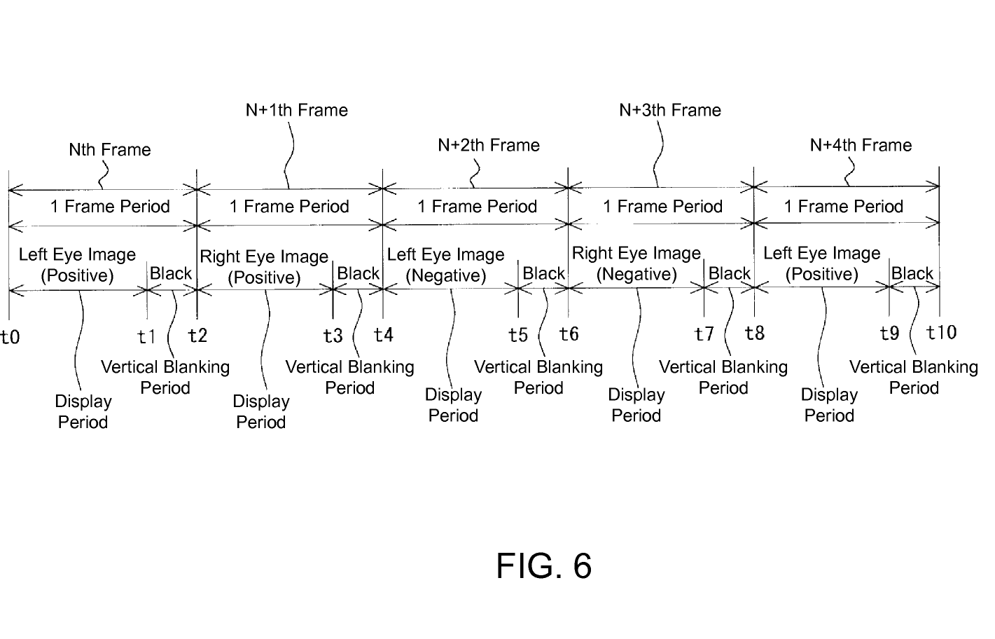

FIG. 6 shows the progression of image writing from an Nth frame to an N+4th frame if the Nth frame is a period for displaying a positive polarity left eye image. Based on FIG. 6, the following can be understood, for example. The period from the time t2 to the time t4 is the N+1th frame, and during the display period during this frame period (period from the time t2 to the time t3), a positive polarity right eye image is written, and a black image is written during the vertical blanking period (period from the time t3 to the time t4) during this frame period.

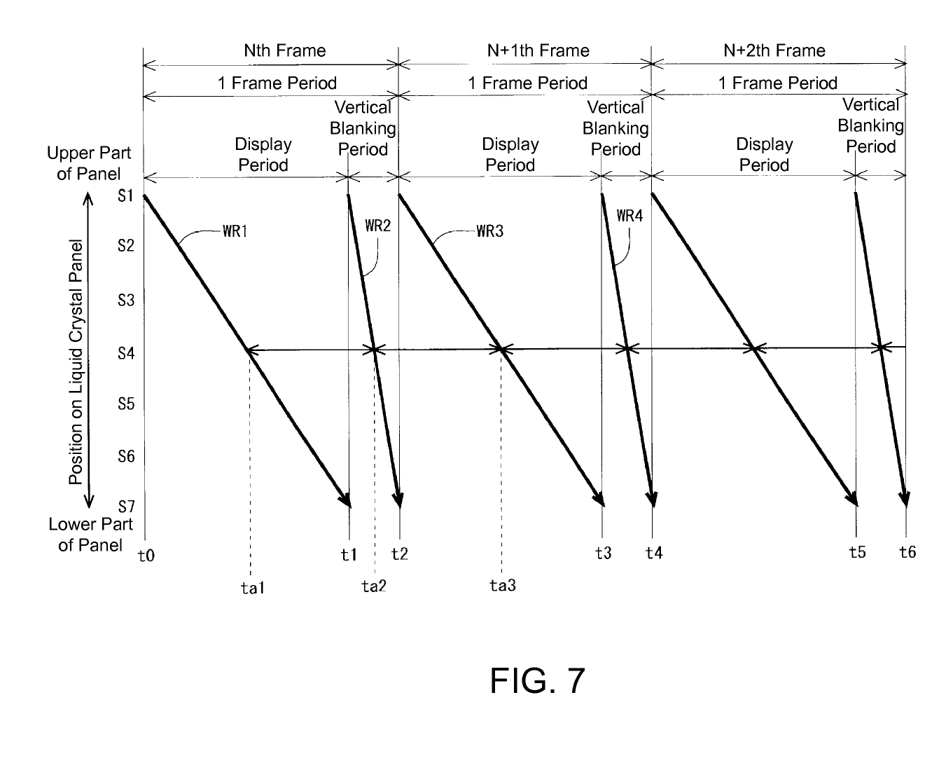

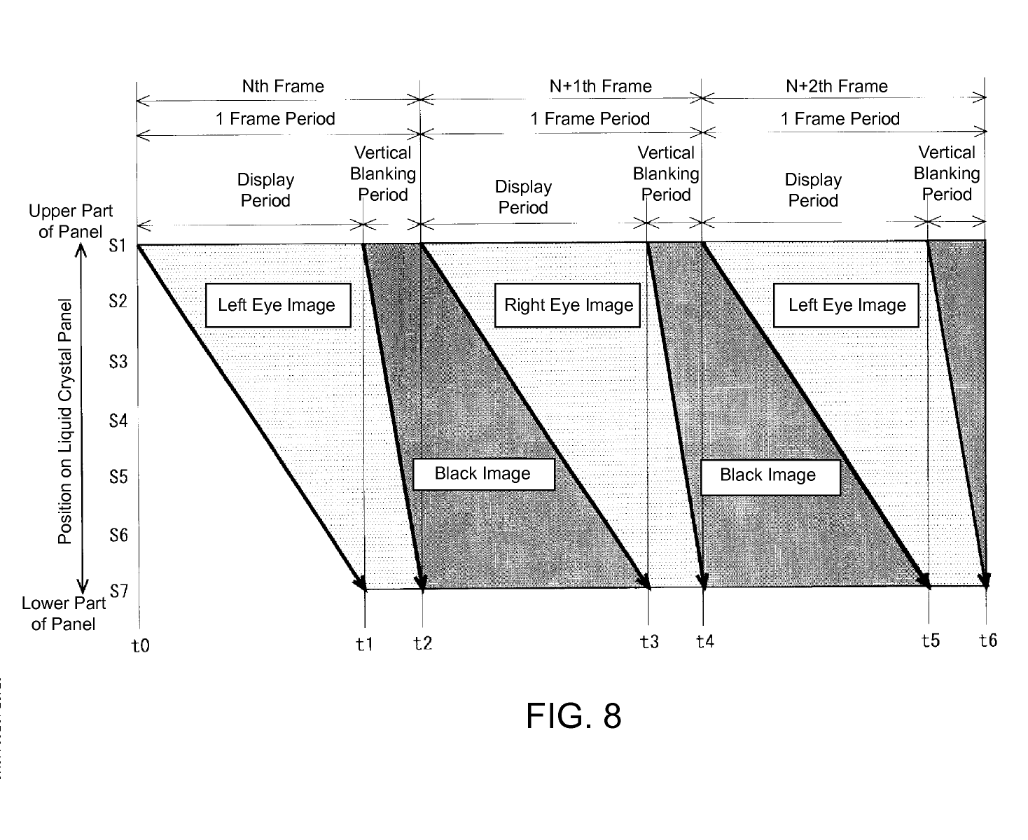

FIGS. 7 and 8, schematically show the progression of pixel writing in the respective regions on the liquid crystal panel 10. The positions on the liquid crystal panel 10 are separated into the segments S1 to S7. During the Nth frame, the left eye image is written in order from the top of the panel to the bottom of the panel from the time t0 to the time t1 (see arrow with the reference character WR1 in FIG. 7), and a black image is written in order from the top of the panel to the bottom of the panel from the time t1 to the time t2 (see arrow with the reference character WR2 in FIG. 7). In the N+1th frame, a right eye image is written in order from the top of the panel to the bottom of the panel from the time t2 to the time t3 (see arrow with reference character WR3 in FIG. 7), and a black image is written in order from the top of the panel to the bottom of the panel from the time t3 to the time t4 (see arrow with reference character WR4 in FIG. 7). Such operations are repeated from the N+2nd frame and thereafter.

Here, when focusing on the region corresponding to the segment S4 among the regions on the liquid crystal panel 10, for example, the left eye image is written at the time ta1, the black image is written during the time ta2, and the right eye image is written during the time ta3. Therefore, in the respective regions, from the time ta1 to the time ta2, the left eye image is displayed, and from the time ta2 to the time ta3, the black image is displayed. The vertical blanking period is shorter than the display period as described above, and thus, the display period of the black image becomes shorter in the order of the region corresponding to the segment S4 to the region corresponding to the segment S1, and in the order of the region corresponding to the segment S4 to the region corresponding to the segment S7, the display period for the black image becomes longer. Therefore, as shown in FIG. 8, the black insertion rate becomes gradually larger from the top of the panel to the bottom of the panel.

<1.4 Control of Intensity of Light Emitted from LEDs>

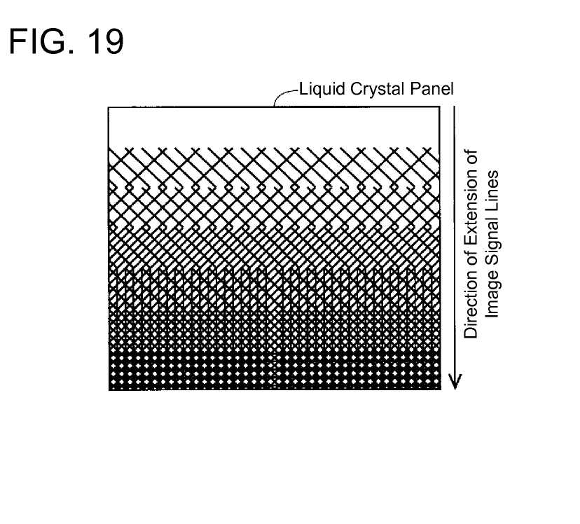

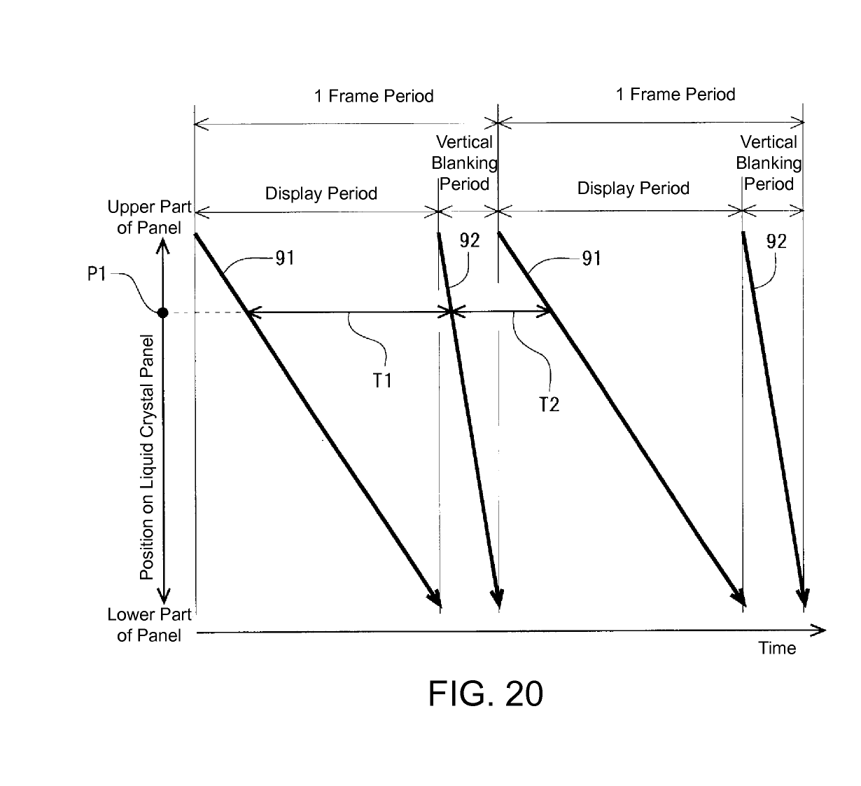

Based on the assumption that three dimensional display is to be performed as described above, the method by which the intensity of light emitted by the LEDs 21 is controlled in the present embodiment will be described. In the present embodiment, the black insertion rate becomes gradually larger from the top of the panel to the bottom of the panel (see FIG. 8). Thus, if the intensity of light for all LEDs 21 were controlled in the same manner, then due to the difference in luminance in different positions of the liquid crystal panel 10, a graded luminance unevenness such as that shown in FIG. 19 occurs. In the present embodiment, the segment-based illumination control circuit 42 in the backlight control circuit 40 controls the intensity of light emitted by the LEDs 21 for each segment such that the intensity of light radiated to the liquid crystal panel 10 becomes gradually brighter from the top of the panel to the bottom of the panel. In other words, as shown in FIG. 9, the intensity of light emitted by the LEDs 21 gradually increases from the segment S1 to the segment S7. That is, in each region on the liquid crystal panel 10, the intensity of light emitted from the LEDs 21 is determined based on the black insertion rate such that the intensity of light emitted from the LEDs 21 becomes greater the higher the black insertion rate is, and the intensity of light emitted from the LEDs 21 becomes less the lower the black insertion rate is.

If the scanning of the scan signal lines GL is performed in the order of the top of the panel to the bottom of the panel, the black insertion rate becomes larger from the top of the panel to the bottom of the panel, and thus, the intensity of light emitted from the LEDs 21 becomes gradually higher from the segment S7 to the segment S1.

The intensity of light emitted by the LEDs depends on the size of the current driving the LEDs (hereinafter, the “drive current”). Specifically, the greater the drive current is the greater the intensity of light emitted by the LEDs, and the smaller the drive current is the less the intensity of light emitted by the LEDs. In the present embodiment, the drive current depends on the segment. Specifically, the drive current is gradually increased from the segment S1 to the segment S7. As a result, the intensity of light emitted by the LEDs 21 becomes gradually larger from the segment S1 to the segment S7. In this manner, in the present embodiment, in order to control the intensity of light emitted by the LEDs 21 for each segment, the segment-based illumination control circuit 42 in the backlight control circuit 40 controls the drive current for each segment.

<1.5 Effects>

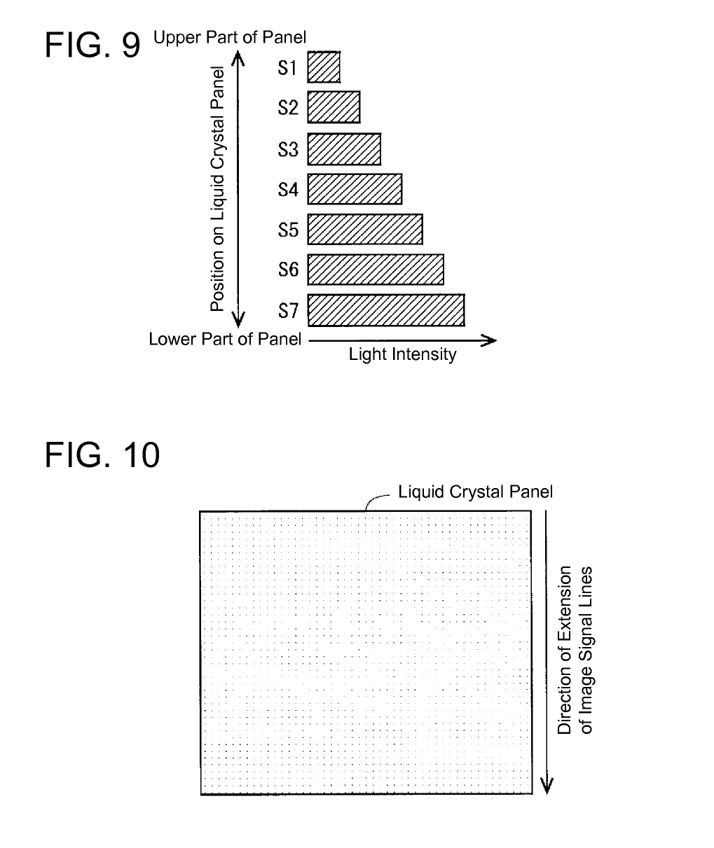

According to the present embodiment, in order to attain three dimensional display in the liquid crystal display device, a black image is written during the vertical blanking period of each frame. In other words, whereas writing of normal images (left eye image or right eye image) takes a longer period of time, writing of the black image takes a relatively shorter period of time. Thus, the black insertion rate differs based on the position in the vertical direction (direction in which the image signal line extends) on the liquid crystal panel 10. However, in the present embodiment, the intensity of light emitted by the LEDs 21 is determined based on the black insertion rate. Specifically, the intensity of light emitted by the LEDs 21 included in the segments S1 to S7 is controlled such that the greater the black insertion rate is the higher the intensity of light emitted by the LEDs 21 is. In this manner, the difference in luminance in the vertical direction on the liquid crystal panel 10 becomes small. If a black image is written during the vertical blanking period in order to attain three dimensional display in this manner, then the graded luminance unevenness shown in FIG. 19 does not occur, and display having a substantially even luminance throughout can be performed as shown in FIG. 10.

As described above, according to the present embodiment, in a liquid crystal display device that can perform three dimensional display, graded luminance unevenness does not occur, and a decrease in image quality resulting from crosstalk is mitigated.

### 1.6 Modification Examples

### 1.6.1 Modification Example 1

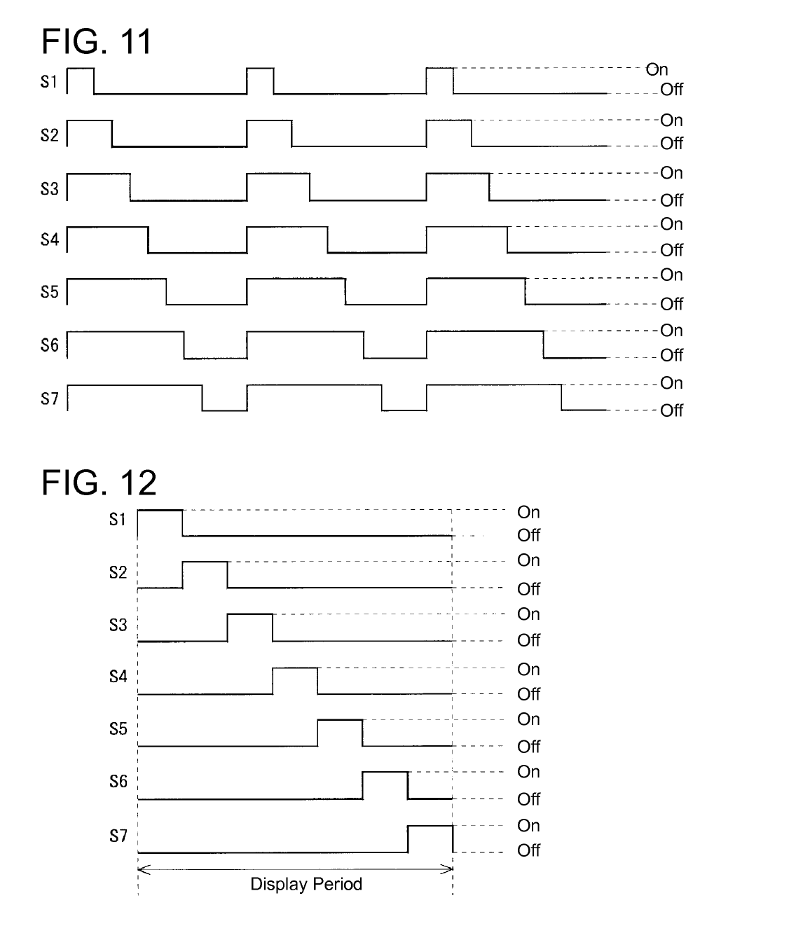

In Embodiment 1 above, the current (drive current) for controlling the LEDs 21 was controlled to control the intensity of light emitted by the LEDs 21, but the present invention is not limited thereto. A configuration may be adopted in which the duty cycle showing the ratio of illumination periods of the LEDs 21 is determined per segment such that the LEDs 21 included in the segments S1 to S7 are switched ON and OFF based on this duty cycle, thereby controlling the intensity of light emitted by the LEDs 21. In the present modification example, as shown in FIG. 11, the duty cycle becomes gradually larger from the segment S1 to the segment S7. As a result, the intensity of light emitted by the LEDs 21 becomes gradually larger from the segment S1 to the segment S7.

### 1.6.2 Modification Example 2

FIG. 12 is a drawing for describing the method of driving a backlight 20 of Modification Example 2 of Embodiment 1. In the present modification example, the backlight 20 is driven according to the scan driving method (LEDs 21 constituting the backlight 20 are illuminated sequentially in the vertical direction of the liquid crystal panel 10). Specifically, the LEDs 21 included in the segment S1 are illuminated during a prescribed period after image writing in a region corresponding to the segment S1 is finished, and LEDs 21 included in the segment S2 are illuminated during a prescribed period after writing in a region corresponding to the segment S2 is finished. This similarly applies to LEDs 21 included in the segments S3 to S7. In the present modification example, the segment-based illumination control circuit 42 (see FIG. 1) outputs backlight control signals BS(1) to BS(7) respectively to the segments S1 to S7 such that the LEDs 21 included in the segments S1 to S7 are sequentially illuminated at each prescribed period as shown in FIG. 12.

According to the present modification example, the LEDs 21 are turned ON/OFF sequentially for each segment. Thus, during a period when display of normal images (left eye image or right eye image) occurs in a region corresponding to a certain segment, LEDs 21 in other segments are turned OFF. As a result, a situation in which the viewer perceives a plurality of images mixed together is mitigated. In this manner, according to the present modification example, crosstalk is effectively mitigated, and it is possible to improve display quality when performing three dimensional display.

### 2. Embodiment 2

<2.1 Configuration and Summary of Operation>

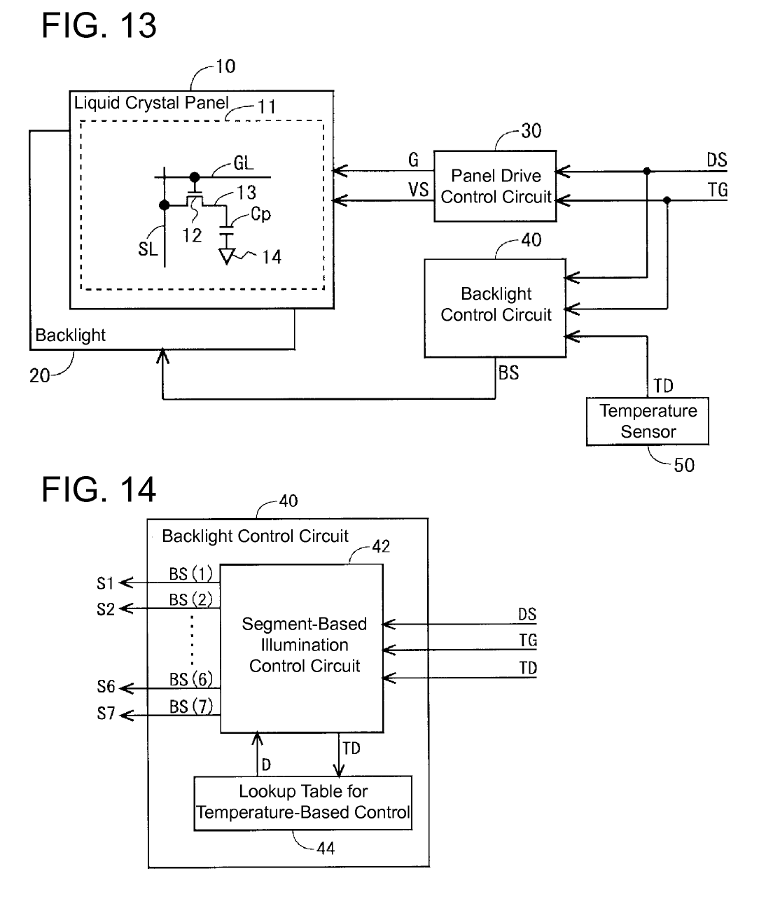

FIG. 13 is a block diagram showing an overall configuration of a liquid crystal display device of Embodiment 2 of the present invention. In the present embodiment, a temperature sensor 50 is provided in addition to the components in Embodiment 1. The temperature sensor 50 is a temperature detection unit. The temperature sensor 50 detects the temperature around the liquid crystal display device and outputs temperature data TD indicating the detected temperature. This temperature data TD is sent to the backlight control circuit 40. As long as the temperature data TD is sent to the backlight control circuit 40, the temperature sensor 50 may be disposed inside the liquid crystal module or outside the liquid crystal module. The backlight control circuit 40 outputs a backlight control signal BS on the basis of a digital image signal DS, a group of timing signals TG, and the temperature data TD. The liquid crystal panel 10, the backlight 20, and the panel drive control circuit 30 are similar to those of Embodiment 1, and thus, descriptions thereof are omitted.

FIG. 14 is a block diagram that shows a backlight control circuit 40 of the present embodiment. As shown in FIG. 14, the backlight control circuit 40 includes a segment-based illumination control circuit 42 and a lookup table 44 for temperature-based control. The temperature data TD is sent to the segment-based illumination control circuit 42 in the backlight control circuit 40. The segment-based illumination control circuit 42 controls the intensity of light of the LEDs 21 for each segment based on the digital image signal DS, the group of timing signals TG, and the temperature data TD. In this case, the segment-based illumination control circuit 42 obtains control data D from the lookup table 44 for temperature-based control using the temperature data TD as a key. The segment-based illumination control circuit 42 adjusts the intensity of the light emitted by the LEDs 21 included in the segments S1 to S7 on the basis of the control data D. In other words, the segment-based illumination control circuit 42 in the present embodiment controls the intensity of light emitted by the LEDs 21 included in the respective segments S1 to S7 based on the control data D obtained based on the temperature data TD in addition to the digital image signal DS and the group of timing signals TG.

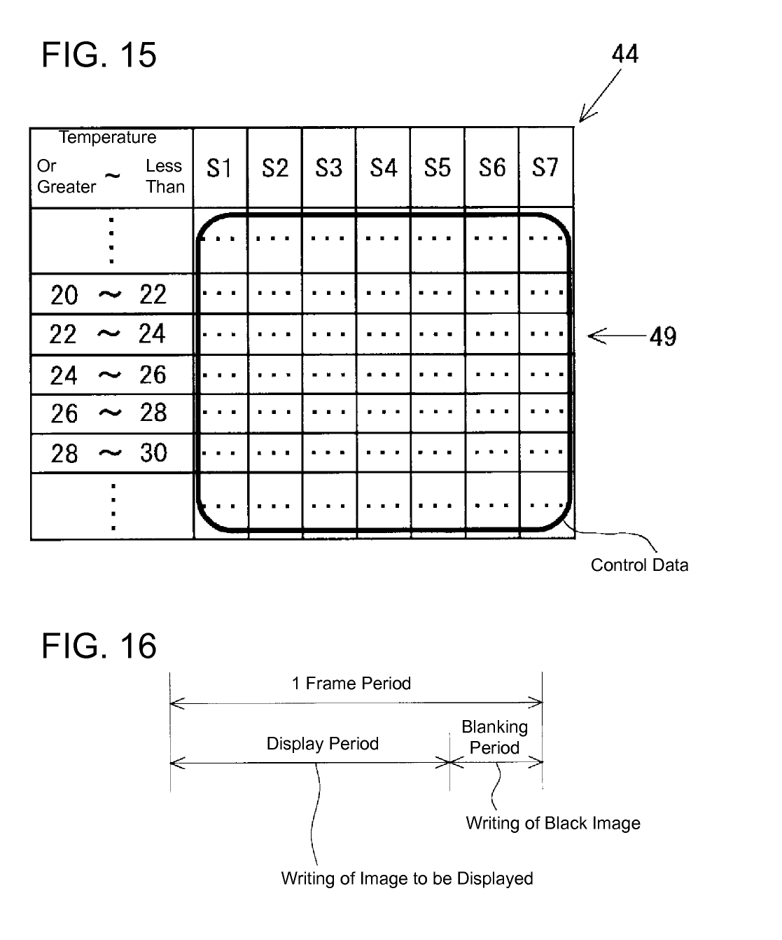

FIG. 15 shows one configuration example of the lookup table 44 for temperature-based control in the present embodiment. As shown in FIG. 15, the lookup table 44 for temperature-based control stores control data at each prescribed temperature range for the segment S1 to the segment S7. The lookup table 44 for temperature-based control shown in FIG. 15 is one example, and the temperature can be graded for every five degrees, for example.

<2.2 Control of Intensity of Light Emitted from LEDs>

In the present embodiment also, similar to Embodiment 1, the intensity of light emitted by the LEDs 21 is adjusted based on the black insertion rate such that the intensity of light emitted by the LEDs 21 is higher the greater the black insertion rate is in each region on the liquid crystal panel 10, and the intensity of light emitted by the LEDs 21 is less the smaller the black insertion rate is. However, in the present embodiment, when determining the intensity of light emitted by the LEDs 21 included in the segments S1 to S7, the temperature around the liquid crystal display device is taken into account.

If a lookup table 44 for temperature-based control such as that shown in FIG. 15 is to be used, then if the temperature indicated by the temperature data TD is 23°, then the intensity of light of the LEDs 21 included in the segments S1 to S7 is adjusted based on the control data in the row shown by the arrow indicated by the reference character 49. As described above, in the present embodiment, the intensity of light of the LEDs 21 is gradually increased from the segment S1 to the segment S7 while taking into account the temperature surrounding the liquid crystal display device.

As a method of controlling the intensity of light of the LEDs 21, a method in which the drive current is controlled may be used, or a method in which the LEDs 21 are switched from ON and OFF on the basis of the duty cycle determined for each segment may be used.

<2.3 Effects>

According to the present embodiment, similar to Embodiment 1, a decrease in image quality resulting from crosstalk is mitigated without causing graded luminance unevenness in a liquid crystal display device that can display in three dimensions. Also, the responsiveness of the liquid crystal depends on the temperature, and thus, if control of the intensity of light emitted by the LEDs 21 is performed without taking into consideration the temperature, then luminance unevenness can occur due to the difference in luminance depending on the position on the liquid crystal panel 10 depending on the temperature surrounding the liquid crystal display device. However, in the present embodiment, the intensity of light emitted by the LEDs 21 is adjusted based on the temperature surrounding the liquid crystal display device, and thus, it is possible to mitigate uneven luminance caused by temperature change.

### 3. Embodiment 3

<3.1 Configuration and the Like>

A liquid crystal display device that can display in three dimensions was described as an example in Embodiment 1 and Embodiment 2, but the present invention is not limited thereto. In the present embodiment, a liquid crystal display device other than one that can display in three dimensions will be described as an example.

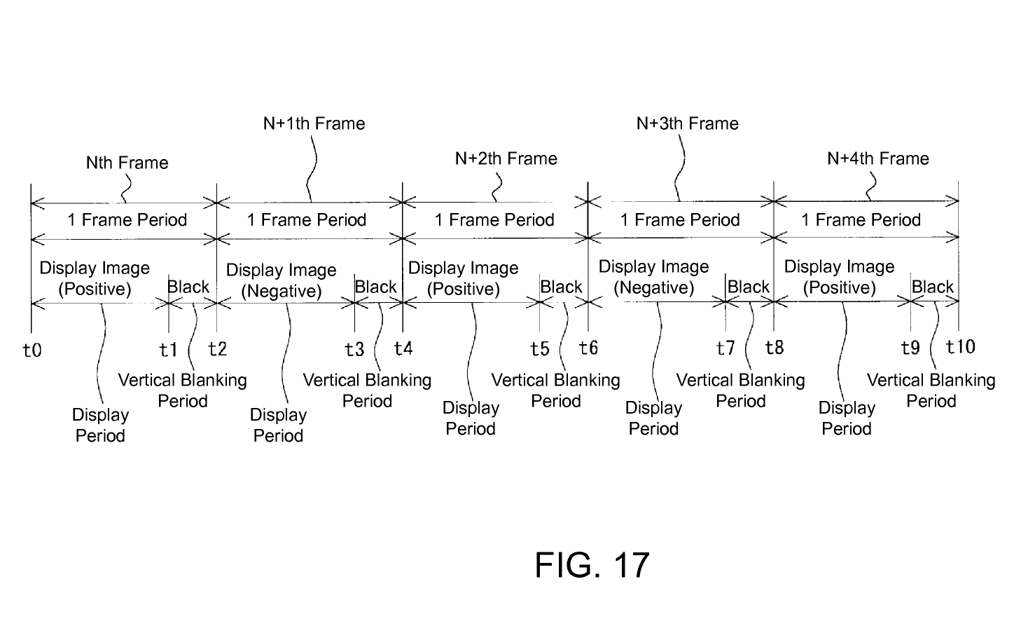

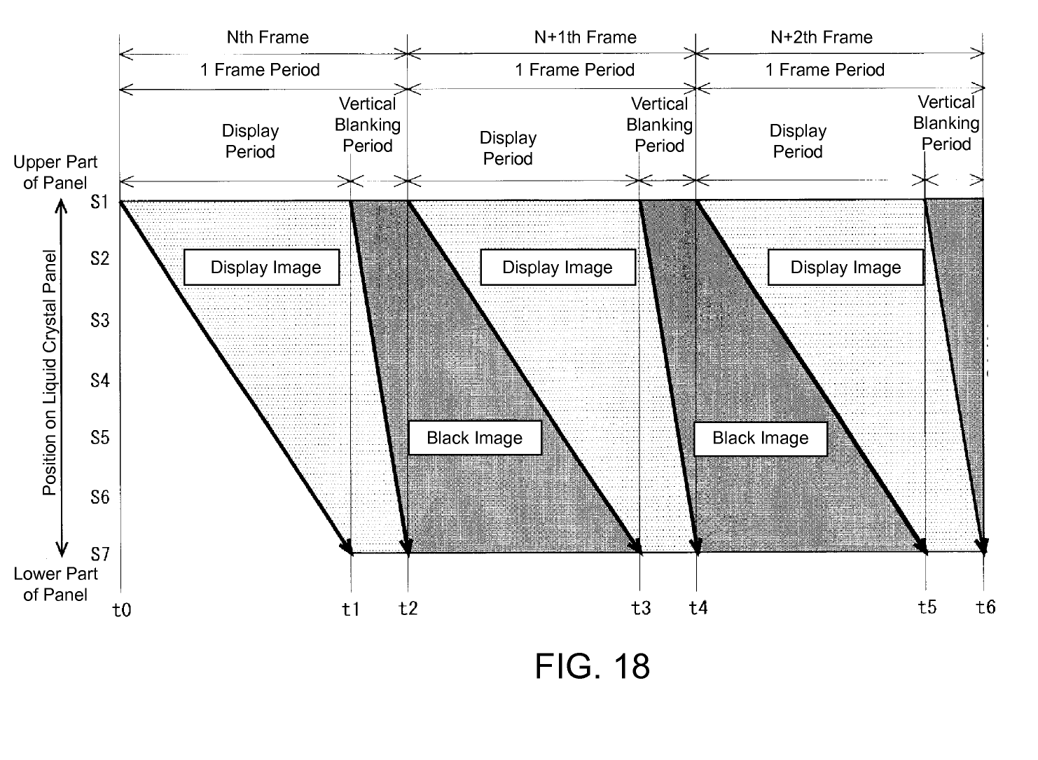

The overall configuration and configuration of the backlight control circuit 40 is similar to that of Embodiment 1 (see FIGS. 1 to 4). However, in the present embodiment, only two dimension display, and not three dimensional display, is performed. One frame period includes a display period during which writing of a normal image (here referred to as an “image to be displayed”) and a vertical blanking period, and similar to Embodiment 1, a black image is written to the liquid crystal panel 10 during the vertical blanking period (see FIG. 16). Also, if it is assumed that the Nth frame is a period for displaying a positive image to be displayed, then the progression of image writing from the Nth frame to the N+4th frame is as shown in FIG. 17. In other words, during each frame period, a black image is written during the vertical blanking period, and a positive image to be displayed and a negative image to be displayed are written in alternating frame periods. As for the progression of image writing in respective positions on the liquid crystal panel 10, as shown in FIGS. 7 and 18, aside from the fact that writing of the image to be displayed is performed during the display period during each frame period, the present embodiment is similar to Embodiment 1. In the present embodiment, a black image is written in order to mitigate the occurrence of motion blur when displaying video. Also, in the present embodiment, an example was described of alternating the polarity per frame, but the present invention is not limited thereto.

<3.2 Control of Intensity of Light Emitted from LEDs>

In the present embodiment also, similar to Embodiment 1, the black insertion rate becomes gradually larger from the top of the panel to the bottom of the panel (see FIG. 18). Also, in each region on the liquid crystal panel 10, the intensity of light emitted from the LEDs 21 is determined based on the black insertion rate such that the intensity of light emitted from the LEDs 21 becomes greater the higher the black insertion rate is, and the intensity of light emitted from the LEDs 21 becomes less the lower the black insertion rate is. Therefore, as shown in FIG. 9, the intensity of light emitted by the LEDs 21 gradually increases from the segment S1 to the segment S7 in the present embodiment also. If the scanning of the scan signal lines GL is performed in the order of the top of the panel to the bottom of the panel, the intensity of light emitted from the LEDs 21 becomes gradually higher from the segment S7 to the segment S1.

<3.3 Effects>

According to the present embodiment, in order to mitigate motion blur when displaying video in the liquid crystal display device, a black image is written during the vertical blanking period of each frame. In other words, whereas writing of normal images (image to be displayed) takes a longer period of time, writing of the black image takes a relatively shorter period of time. Thus, the black insertion rate differs based on the position in the vertical direction (direction in which the image signal line extends) on the liquid crystal panel 10. However, the intensity of light emitted by the LEDs 21 is determined based on the black insertion rate such that the intensity of light emitted by the LEDs 21 becomes larger as the black insertion rate increases. In this manner, the difference in luminance in the vertical direction on the liquid crystal panel 10 becomes small. If a configuration is adopted in which the black image is written during the vertical blanking period to mitigate motion blur when displaying video in this manner, then the graded luminance unevenness shown in FIG. 19 does not occur, and display having a substantially even luminance throughout the panel as shown in FIG. 10 is realized.

As described above, according to the present embodiment, a liquid crystal display device by which it is possible to mitigate a decrease in image quality when displaying video without graded luminance unevenness is realized. The intensity of light emitted by the LEDs 21 may be adjusted based on the temperature surrounding the liquid crystal display device as in Embodiment 2. In this manner, it is possible to mitigate luminance unevenness resulting from temperature change.

<4. Other Configurations>

Increasing the number of segments is effective to further reduce luminance change in the vertical direction in the liquid crystal panel 10. However, the luminance change can also be decreased by optimizing the diffusion sheet provided between the liquid crystal panel 10 and the LEDs 21 (backlight 20).

### DESCRIPTION OF REFERENCE CHARACTERS

10 liquid crystal panel
11 display unit
20 backlight
21 LED
30 panel drive control circuit
40 backlight control circuit
42 segment-based illumination control circuit
44 lookup table for temperature-based control
BS, BS(1) to BS(7) backlight control signal
S1 to S7 segment
D control data
TD temperature data
TE temperature signal

1. A liquid crystal display device, comprising:
a liquid crystal panel including a plurality of scan signal lines and a plurality of image signal lines that intersect with the plurality of scan signal lines;
a plurality of light sources as a backlight that radiates light to a rear surface of the liquid crystal panel;
a light source control unit that controls an intensity of light emitted by the plurality of light sources; and
a liquid crystal panel driving unit that drives the liquid crystal panel,
wherein the plurality of light sources are divided into a plurality of groups such that a set of light sources aligned in a direction extending along the plurality of scan signal lines belongs to a same group,
wherein the liquid crystal panel driving unit writes an image to be displayed to the liquid crystal panel every frame period from one edge to an opposite edge of the liquid crystal panel in a direction extending along the plurality of image signal lines, and writes a black image from said one edge to said opposite edge of the liquid crystal panel during a vertical blanking period in each frame period, and
wherein the light source control unit controls the intensity of light emitted the plurality of light sources for each group such that the intensity of light radiated to the liquid crystal panel increases from said one edge to said opposite edge of the liquid crystal panel.

2. The liquid crystal display device according to claim 1,
wherein the liquid crystal panel driving unit writes a left eye image and a right eye image as the image to be displayed to the liquid crystal panel in alternating frame periods, and
wherein the liquid crystal panel displays a three dimensional image by alternately displaying the left eye image and the right eye image.

3. The liquid crystal display device according to claim 2, wherein the light source control unit sequentially illuminates a set of light sources belonging to each group during each prescribed period, starting from a group at said one edge of the liquid crystal panel to a group at said opposite edge of the liquid crystal panel.

4. The liquid crystal display device according to claim 1, wherein the light source control unit adjusts the intensity of light emitted from each group of the light sources on the basis of temperature data indicating a temperature.

5. The liquid crystal display device according to claim 4, further comprising:
a temperature detection unit that detects a surrounding temperature,
wherein the light source control unit receives, from the temperature detection unit, data indicating a temperature detected by the temperature detection unit as the temperature data.

6. The liquid crystal display device according to claim 4, wherein the light source control unit receives, from an external temperature detection unit, data indicating a temperature detected by the external temperature detection unit as the temperature data.

7. The liquid crystal display device according to claim 4, further comprising:
a lookup table that stores control data for adjusting the intensity of light emitted by the light sources on the basis of temperature, the control data being listed for each group of the light sources for possible temperatures that would be indicated by the temperature data,
wherein the light source control unit adjusts the intensity of light emitted by each group of the light sources in accordance with the control data listed in the lookup table for the temperature indicated by the temperature data.

8. The liquid crystal display device according to claim 1, wherein the light source control unit switches on and off a set of light sources belonging to each group on the basis of a duty ratio pre-determined for each group in order to control the intensity of light emitted by each group among the plurality of light sources.

9. The liquid crystal display device according to claim 1, wherein the light source control unit controls for each group a size of a current for driving the light sources in order to control the intensity of light emitted from each group among the plurality of light sources.

10. The liquid crystal display device according to claim 1, wherein the plurality of light sources are light-emitting diodes.

11. The liquid crystal display device according to claim 1, wherein the plurality of light sources are disposed in a planar manner to a rear of the liquid crystal panel.

12. The liquid crystal display device according to claim 1, wherein the plurality of light sources are disposed in a row along a side face of the liquid crystal panel.

13. A method of controlling a liquid crystal display device including: a liquid crystal panel having a plurality of scan signal lines and a plurality of image signal lines intersecting with the plurality of scan signal lines; and a plurality of light sources as a backlight that radiates light to a rear surface of the liquid crystal panel, the method comprising:
controlling an intensity of light emitted by the plurality of light sources; and
driving the liquid crystal panel,
wherein the plurality of light sources are divided into a plurality of groups such that a set of light sources aligned in a direction extending along the plurality of scan signal lines belongs to a same group,
wherein, in the step of driving the liquid crystal panel, an image to normally be displayed to the liquid crystal panel is written to the liquid crystal panel every frame period from one edge to an opposite edge of the liquid crystal panel in a direction extending along the plurality of image signal lines, and a black image is written to the liquid crystal panel from said one edge to said opposite edge of the liquid crystal panel during a vertical blanking period in each frame period, and
wherein, in the step of controlling the light sources, the intensity of light emitted from the plurality of light sources is controlled for each group such that the intensity of light radiated to the liquid crystal panel increases from said one edge to said opposite edge of the liquid crystal panel.

14. The method of controlling a liquid crystal display device according to claim 13, wherein, in the step of controlling the light sources, the intensity of light emitted from the plurality of light sources is adjusted for each group on the basis of temperature data indicating a detected temperature.
